(19) United States
(12) Patent Application Publication
(10) Pub. No.: US 2026/0155359 A1
(43) Pub. Date: Jun. 4, 2026

(54) NEGATIVE ELECTRODE OF RECHARGEABLE LITHIUM BATTERY AND RECHARGEABLE LITHIUM BATTERY INCLUDING SAME

(71) Applicant: SAMSUNG SDI CO., LTD., Yongin-si (KR)

(72) Inventors: Haeju KIM, Yongin-si (KR); Woosung CHOI, Yongin-si (KR); Jaegyun DOO, Yongin-si (KR); Meenkyoung JUNG, Yongin-si (KR); Seung-Young PARK, Yongin-si (KR)

(73) Assignee: SAMSUNG SDI CO., LTD., Yongin-si (KR)

(21) Appl. No.: 19/407,938

(22) Filed: Dec. 3, 2025

(30) Foreign Application Priority Data
Dec. 4, 2024 (KR) 10-2024-0178880
Dec. 3, 2025 (KR) 10-2025-0189840

(51) Int. Cl. H01M 4/36; H01M 4/02; H01M 4/133; H01M 4/134; H01M 4/38; H01M 4/587; H01M 10/052

(52) U.S. Cl. CPC H01M 4/366; H01M 4/133; H01M 4/134; H01M 4/364; H01M 4/386; H01M 4/587; H01M 2004/027; H01M 10/052

(57) ABSTRACT

Disclosed are a negative electrode for a rechargeable lithium battery, and a rechargeable lithium battery including the negative electrode. The negative electrode includes a current collector, a first active material layer on the current collector and including a first active material, and a second active material layer on the first active material layer and including a second active material. The first active material includes a Si-based active material and the first active material layer is non-oriented layer; and the second active material is crystalline carbon and the second active material layer is an oriented layer, or the first active material is crystalline carbon and the first active material layer is an oriented layer; and the second active material includes a Si-based active material and the second active material layer is a non-oriented layer.

### CROSS-REFERENCE TO RELATED APPLICATION

This application claims priority to Korean Patent Application No. 10-2024-0178880 filed with the Korean Intellectual Property Office on Dec. 4, 2024, and Korean Patent Application No. 10-2025-0189840 filed with the Korean Intellectual Property Office on Dec. 3, 2025, the entire contents of which are incorporated herein by reference.

### BACKGROUND

### (a) Field

Negative electrode for a rechargeable lithium battery, and rechargeable lithium battery including the negative electrode are disclosed.

### (b) Description of the Related Art

The increasing presence of electronic devices such as, e.g., mobile phones, laptop computers, and electric vehicles, using batteries drives increases in demand for rechargeable batteries with relatively high capacity and lighter weight. Improving the performance of rechargeable lithium batteries may be advantageous.

Rechargeable lithium batteries include a positive electrode and a negative electrode including an active material capable of intercalating and deintercalating lithium ions, and an electrolyte solution, and electrical energy is produced by oxidation and reduction reactions when lithium ions are intercalated/deintercalated at the positive and negative electrodes.

### SUMMARY

One or more example embodiments include a negative electrode for a rechargeable lithium battery exhibiting desired or improved high-rate cycle-life characteristics.

Another example embodiment includes a rechargeable lithium battery including the negative electrode.

One or more example embodiments include a negative electrode for a rechargeable lithium battery including a current collector; a first active material layer on the current collector and including a first active material, and a second active material layer on the first active material layer and including a second active material. The first active material includes a Si-based active material and the first active material layer is non-oriented layer; and the second active material is crystalline carbon and the second active material layer is an oriented layer, or the first active material is crystalline carbon and the first active material layer is an oriented layer; and the second active material comprises a Si-based active material and the second active material layer is a non-oriented layer.

Another example embodiment includes a rechargeable lithium battery including the negative electrode; a positive electrode; and a non-aqueous electrolyte.

The negative electrode for a rechargeable lithium battery according to one or more example embodiments may exhibit desired or improved high-rate cycle-life characteristics.

### BRIEF DESCRIPTION OF THE DRAWINGS

FIG. 1 schematically shows the negative electrode for a rechargeable lithium battery according to one or more example embodiments.

FIG. 2 to FIG. 5 are a cross-sectional view schematically showing rechargeable lithium batteries according to some example embodiment.

FIG. 6 is a graph showing the room-temperature cycle-life characteristics of the half-cells according to Examples 1 and 2, and Comparative Examples 1 and 2.

### DETAILED DESCRIPTION

Hereinafter, example embodiments are described in detail. However, these embodiments are examples, the present disclosure is not limited thereto and the present disclosure is defined by the scope of the appended claims.

As used herein, when a specific definition is not otherwise provided, it is understood that when an element such as a layer, film, region, or substrate is referred to as being “on” another element, the element may be “directly on” the other element, or intervening elements may also be present.

Unless otherwise specified in this specification, what is indicated in the singular may also include the plural. In addition, unless otherwise specified, “A or B” may mean “including A, including B, or including A and B.”

As used herein, the expression “combination thereof” may include a mixture, a laminate, a complex, a copolymer, an alloy, a blend, a reactant of constituents.

In the present disclosure, when a definition is not otherwise provided, a particle diameter may be an average particle diameter. The particle diameter indicates an average particle diameter (D50) where a cumulative volume is about 50 volume % in a particle size distribution. The average particle diameter (D50) may be measured by a method well known to those skilled in the art, for example, by a particle size analyzer, or by a transmission electron microscope (TEM) image, or a scanning electron microscope (SEM) image. In some example embodiments, a dynamic light-scattering measurement device may be used to perform a data analysis, and the number of particles is counted for each particle size range, and from this, the average particle diameter (D50) value may be readily obtained through a calculation. The particle size may be measured by a laser diffraction method. The laser diffraction may be obtained by distributing particles to be measured in a distribution solvent, and introducing the distribution solvent to a commercially available laser diffraction particle measuring device (e.g., MT 3000 available from Microtrac, Inc.), irradiating ultrasonic waves of about 28 kHz at a power of about 60 W, and calculating an average particle diameter (D50) in the 50% standard of particle distribution in the measuring device.

In some example embodiments, an average particle diameter may be measured by various techniques, and for example, may be measured by a particle size analyzer.

In some example embodiments, a thickness may be measured by a SEM or a TEM image for the cross-section, but the measurement technique is not limited thereto, and the thickness may be measured by any techniques, as long as the techniques may measure the thickness in the related arts. The thickness may be an average thickness.

As used herein, soft carbon refers to graphitizable carbon materials and are readily graphitized by heat treatment at a high temperature, e.g., about 2800° C., and hard carbon refers to non-graphitizable carbon materials and are not substantially or slightly graphitized by heat treatment. The terms soft carbon and hard carbon may be well known in the related arts.

In some example embodiments, the crystalline carbon and the amorphous carbon may be distinguished through XRD measurement. The crystalline carbon includes natural graphite and artificial graphite. Natural graphite may indicate graphite which may be naturally generated by separating the graphite from minerals, and when measured by XRD, the interplanar spacing (d002) of the (002) plane may be in a range of about 3.350 Å to about 3.360 Å. Artificial graphite may indicate graphite manufactured by graphitization, and when (e.g., when) measured by XRD, the interplanar spacing (d002) of the (002) plane may be in a range of about 3.355 Å to about 3.365 Å. Meanwhile, the amorphous carbon may have the interplanar spacing (d 002) of the (002) plane in a range of about 3.34 Å or less, when measured by XRD. The XRD may be measured using CuKα ray as a target ray with an X-ray diffraction analyzer (e.g., product name: X'Pert, manufacturer: Malvern Panalytical) and by removing a monochromator to improve a peak intensity resolution. The measurement condition may be 20=10° to 80°, a scan speed (°/S) of 0.044 to 0.089, and a step size (°/step) of 0.013 to 0.039.

In some example embodiments, a weight-average-molecular weight may be measured by using gel permeation chromatography (GPC).

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

A negative electrode for a rechargeable lithium battery according to one or more example embodiments includes a current collector; a first active material layer disposed on the current collector and including a first active material, and a second active material layer disposed on the first active material layer and comprising a second active material.

In one or more example embodiments, the first active material layer may be a non-oriented layer, and the second active material layer may be an oriented layer. In another example embodiments, the first active material layer may be an oriented layer, and the second active material layer may be a non-oriented layer. For example, a lower layer may be a non-oriented layer, and an upper layer may be an oriented layer, and in another example embodiment, the bottom may be an oriented layer, and the upper portion may be a non-oriented layer.

When the active material layer is a non-oriented layer, the active material includes a Si-based active material, and in other example embodiments, when the active material layer is an oriented layer, the active material is crystalline carbon.

In one or more example embodiments, when the first active material layer is the non-oriented layer and the first active material includes the Si-based active material; and the second active material layer is the oriented layer and the second active material is crystalline carbon, lithium ions are rapidly intercalated at the top during charging and discharging, silicon positioned on the bottom reacts slowly, and the high-rate characteristics such as high-rate cycle-life characteristics may be improved, and thus, this configuration is suitable.

For example, the negative electrode in which the non-oriented layer including the Si-based active material as the first active material is the bottom (first active material layer) and the oriented layer including crystalline carbon as the second active material is the top, may exhibit desired or improved high-rate characteristics.

The negative electrode active material in the oriented layer consists of or includes crystalline carbon, which is suitable, as crystalline carbon enhances the rapid intercalation and deintercalation of lithium ions during charge and discharge through the physical effects of the negative electrode active material standing at a predetermined angle. When other active materials such as the silicon-based active material or amorphous carbon are included in the oriented layer, the silicon-based active material, which has a significant deterioration in the cycle-life characteristics reacts firstly and deteriorates, making the silicon-based active material unsuitable.

The oriented layer indicates that the included negative electrode active material stands substantially vertically to the current collector at a predetermined angle and the non-oriented layer indicates that the included negative electrode active material is substantially horizontally and parallel to the current collector, or is randomly oriented in various orientations.

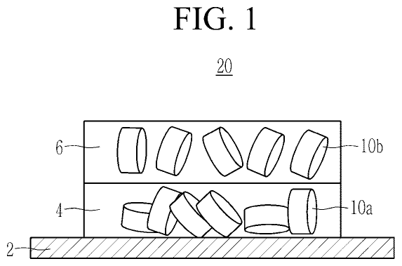

FIG. 1 schematically shows the negative electrode 20 in which the bottom, first active material layer 4 in contact with the current collector 2 is the non-oriented layer 4 and the top, the second active material layer 6 is the oriented layer. As shown in FIG. 1, the negative electrode active material 10a is positioned in random orientations such as, e.g., horizontal, vertical direction, or the like, to the current collector 2 in the non-oriented layer 4, and the negative electrode active material 10b is presented in a substantially vertical direction with respect to a surface of the current collector 2 in the oriented layer 6.

In one or more example embodiments, the oriented layer may have a peak intensity ratio (I₍₀₀₂₎/I₍₁₁₀₎) of a peak intensity at a (002) plane relative to a peak intensity at a (110) plane in a range of about 50 to about 200 when X-ray diffraction is measured by using a CuKα ray, about 100 to about 200, or about 110 to about 200. When the peak intensity ratio (I₍₀₀₂₎/I₍₁₁₀₎) of the oriented layer falls within the above range, the performances related to the rapid reaction speed of the oriented layer may be further maximized.

In one or more example embodiments, the non-oriented layer have a peak intensity ratio (I₍₀₀₂₎/I₍₁₁₀₎) of a peak intensity at a (002) plane relative to a peak intensity at a (110) plane of about 300 or more when X-ray diffraction is measured by using a CuKα ray, more than about 300 and less than or equal to 500, or about 350 to about 500.

The XRD may be measured using CuKα ray as a target ray with an X-ray diffraction analyzer (e.g., product name: X'Pert, manufacturer: Malvern Panalytical) and by removing a monochromator to improve a peak intensity resolution. The measurement condition may be 2θ=10° to 80°, a scan speed (°/S) of 0.044 to 0.089, and a step size (°/step) of 0.013 to 0.039.

The X-ray diffraction analysis may also be conducted for the negative electrode obtained by separating from the battery which is charged at about 0.1 C to about 0.5 C for once, or 1 time, to 5 times, and full discharged at about 0.1 C to about 0.5 C to about 2.5 V to about 3 V. Thus, the peak intensity ratio (I₍₀₀₂₎/I₍₁₁₀₎) of the negative electrode according to one or more example embodiments is substantially maintained after a number of charges and discharges.

The peak intensity ratio (I₍₀₀₂₎/I₍₁₁₀₎) of the first active material layer is obtained by taking off the second active material layer utilizing a tape after charge and discharge and conducting an X-ray diffraction analysis on the active material layer attached to the current collector.

In one or more example embodiments, the crystalline carbon may be or include artificial graphite, natural graphite, or a combination thereof. In another example embodiment, the crystalline carbon may be or include artificial graphite or a combination of artificial graphite and natural graphite.

In one or more example embodiments, the negative electrode active material of the non-oriented layer is or includes a Si-based negative electrode active material. The Si-based negative electrode active material may be a silicon-carbon composite.

The silicon-carbon composite may be or include a composite of silicon and amorphous carbon. For example, the silicon-carbon composite may include silicon particles, and an amorphous carbon coated on the surface of the silicon particle. In one or example embodiments, the silicon-carbon composite may include a secondary particle (core) in which silicon primary particles are agglomerated, and an amorphous carbon coating layer (shell) is on the secondary particles. The amorphous carbon is also present between the silicon primary particles, for example, to coat the silicon primary particles. For example, the secondary particles may also be distributed in an amorphous carbon matrix. The silicon primary particles may be or include nano silicon particles. The nano silicon particle may have an average particle diameter in a range of about 10 nm to about 900 nm, about 10 nm to about 800 nm, about 10 nm to about 500 nm, about 10 nm to about 300 nm, or about 10 nm to about 200 nm. When the average particle diameter of the silicon particles is within the above range, the substantial volume expansion caused during charge and discharge may be reduced or suppressed, and a breakage of the conductive path due to crushing of particle during charging and discharging may be reduced or prevented. In one or more example embodiments, the particle diameter of the silicon secondary particle is not limited thereto.

The thickness of the amorphous carbon coating layer may be adjusted as desired, but for example, may be in a range of about 2 nm to about 800 nm, about 5 nm to about 600 nm, about 10 nm, to about 400 nm, or about 20 nm to about 200 nm. In one or more example embodiments, the thickness of the amorphous carbon coating layer may be measured by a SEM image or a TEM image for the cross-section of the silicon-carbon composite, but the thickness measurement technique is not limited thereto, and thus, the thickness may be measured by any techniques as long as the thickness of the amorphous carbon coating layer is measured.

The average particle diameter of the silicon-carbon composite may be adjusted as desired, and for example, may be in a range of about 30 μm or less, for example, about 1 μm to about 30 μm, about 2 μm to about 25 μm, about 3 μm to about 20 μm, or about 5 μm to about 15 μm.

Based on 100 wt % of the silicon-carbon composite, an amount of the silicon particle may be in a range of about 30 wt % to about 70 wt %, or about 40 wt % to about 65 wt %. An amount of the amorphous carbon may be, based on the total 100 wt % of the silicon-carbon composite, in a range of about 30 wt % to about 70 wt %, or about 35 wt % to about 60 wt %. When the amounts of the silicon particles and the amorphous carbon are within the above range, higher capacity may be realized.

In another example embodiments, the silicon-carbon composite may further include crystalline carbon. In some example embodiments, the silicon-carbon composite may include a core including crystalline carbon and silicon particles, and an amorphous carbon coating layer on a surface of the core. For example, the silicon-carbon composite may include a core including secondary particles where the silicon primary particles and crystalline carbon are agglomerated, and an amorphous carbon coating layer on the core. The amorphous carbon may be present between the silicon primary particles or between the crystalline carbon, allowing the amorphous carbon to substantially fill the space between the silicon primary particles or the crystalline carbon.

When the silicon-carbon composite includes the silicon particles, the crystalline carbon, and the amorphous carbon, an amount of the crystalline carbon may be in a range of about 10 wt % to about 70 wt %, or about 20 wt % to about 60 wt % based on the total 100 wt % of the silicon particles, the amorphous carbon, and the crystalline carbon. An amount of the amorphous carbon may be in a range of about 20 wt % to about 40 wt %, or about 20 wt % to about 30 wt %, and an amount of the silicon particles may be in a range of about 10 wt % to about 70 wt %, or about 10 wt % to about 60 wt %.

In some example embodiments, the first active material layer or the second active material layer, which is the non-oriented layer, may further include a carbon-based negative electrode active material. The carbon-based negative electrode active material may be or include crystalline carbon, carbon nanotube, or a combination thereof, and in one or more example embodiments, may be or include crystalline carbon and carbon nanotube.

When the first active material layer or the second active material layer, which is the non-oriented layer, includes the Si-based negative electrode active material and the carbon-based negative electrode active material, based on 100 wt % of the first active material layer or the second active material layer, an amount of the Si-based negative electrode active material may be in a range of about 2 wt % to about 20 wt %, and an amount of the carbon-based negative electrode active material may be in a range of about 98 wt % to about 80 wt %. In one or more example embodiments, when the first active material layer or the second active material layer, which is the non-oriented layer, includes the Si-based negative electrode active material, crystalline carbon and carbon nanotubes, based on 100 wt % of the first active material layer or the second active material layer, an amount of the Si-based negative electrode active material may be in a range of about 2 wt % to about 20 wt %, an amount of crystalline carbon may be in a range of about 97 wt % to about 79.9 wt %, and an amount of carbon nanotube may be in a range of about 0.01 wt % to about 0.1 wt %.

In one or more example embodiments, a ratio of the thickness of the first active material layer and the thickness of the second active material layer may be in a range of about 1:1 to about 1:2, or about 1:1 to about 1:1.4.

The first active material layer and the second active material layer have the same composition except for the active material, as further provided below.

The first active material layer and the second active material layer includes a binder, and may further include a conductive material.

In each of the first active material layer and the second active material layer, an amount of the active material may be in a range of about 95 wt % to about 99 wt %, and an amount of the binder may be in a range of about 1 wt % to about 5 wt %. In another example embodiments, an amount of the active material may be in a range of about 91.5 wt % to about 99 wt %, an amount of the binder may be in a range of about 1 wt % to about 5 wt %, and an amount of the conductive material may be in a range of about 0.5 wt % to about 5 wt %.

The binder is configured to improve binding properties of negative electrode active material particles with one another and with a current collector. The binder may include a non-aqueous binder, an aqueous binder, a dry binder, or a combination thereof.

In example embodiments, the non-aqueous-based binder may include at least one of polyvinylchloride, carboxylated polyvinylchloride, polyvinyl fluoride, an ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinyl pyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When the aqueous binder is used as a negative electrode binder, a cellulose-based compound may be further used to provide viscosity. The cellulose-based compound includes one or more of carboxymethyl cellulose, hydroxypropylmethyl cellulose, methyl cellulose, or alkali metal salts thereof. The alkali metal may be or include at least one of Na, K, or Li. The cellulose-based compound may be configured as a thickener, and may also be configured as an aqueous binder.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material is included to provide electrode conductivity, and any electrically conductive material may be included as a conductive material unless the electrically conductive material causes an adverse chemical change in the battery. Examples of the conductive material may be or include a carbon-based material such as at least one of natural graphite, artificial graphite, carbon black, acetylene black, ketjen black, a carbon fiber, a carbon nanofiber, carbon nanotube, or the like; a metal-based material of a metal powder or a metal fiber including at least one of copper, nickel, aluminum, silver, and the like; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, and a combination thereof.

### Method of Preparing Negative Electrode:

The negative electrode according to one or more example embodiments may be prepared by coating a first active material layer composition on a current collector, and drying the first active material layer composition to prepare a first active material layer; coating the second active material layer composition on the first active material layer, and drying the second active material layer composition to prepare a second active material layer; and compressing the negative electrode.

In one or more example embodiments, when a magnetic field is applied between coating and drying, the prepared active material layer may become the oriented layer. For example, when the first active material layer composition is coated, a magnetic field may be applied, and the first active material layer composition is dried, and the first active material layer may be become the oriented layer. Alternatively, when the second active material layer composition is coated, a magnetic field is applied and the second active material layer composition is dried, the second active material layer may be the oriented layer. According to one or more example embodiments, the preparing of the first active material layer may be carried out without applying the magnetic field, and the preparing of the second active material layer may be carried out with applying the magnetic field.

Applying the magnetic field may be carried out by disposing a magnet beneath the current collector. For example, after the magnet is disposed beneath of the current collector, drying may be carried out. Accordingly, the crystalline carbon negative electrode active material included in the active material layer composition may stand at the predetermined or desired angle to the current collector, i.e., may be oriented, and thus, the active material layer may be formed as an oriented layer.

In one or more example embodiments, the first active material layer is prepared, i.e., the non-oriented layer is prepared, and then the second active material layer composition is coated and the magnet is disposed beneath the current collector. Thereafter, drying is carried out to prepare the second active material layer which is the oriented layer, and then compression is carried out, thereby preparing the negative electrode.

In case of forming the first active material layer and the second active material layer on both sides of the current collector, the first active material layer is formed on one side of the current collector, and the first active material layer is formed on the other side of the current collector which does not have the first active material layer, opposite to the side where the first active material layer is formed, and then the second active material layers are formed on each side of the two first active material layers. In another example embodiment, the first active material layer and the second active material may be formed, e.g., sequentially formed, on one side of the current collector and then the first active material layer and the second active material layer are formed, e.g., sequentially formed, on the other side of the current collector.

The magnet may have a magnetic field in a range of about 1000 Gauss to 10000 Gauss. Furthermore, the negative electrode active material compositions may be coated on the current collector and maintained for a duration in a range of about 3 seconds to about 15 seconds, that is, may be exposed to the magnetic field for about 3 seconds to about 15 seconds. In one or more example embodiments, the magnetic field exposure time may be in a range of about 3 seconds to about 12 seconds. The resulting peak intensity ratio (I₍₀₀₂₎/I₍₁₁₀₎)) may vary depending on the magnetic field exposure time.

The first active material layer composition and the second active material layer composition may be prepared by mixing a negative electrode active material, the binder and the conductive material, in a solvent. The viscosities of the first active material layer composition and the second active material layer composition may be adjusted to a value suitable for coating.

The solvent may be or include an organic solvent such as, e.g., N-methyl pyrrolidone, or water, and when the aqueous binder is included as the binder, the solvent may be water.

### Rechargeable Lithium Battery:

Other example embodiments include a rechargeable lithium battery including the negative electrode, a positive electrode, and a non-aqueous electrolyte.

### Positive Electrode:

The positive electrode may include a current collector, and a positive electrode active material layer on the current collector. The positive electrode active material layer includes a positive electrode active material, and may further include a binder and/or a conductive material.

For example, the positive electrode may further include an additive that may be configured as a sacrificial positive electrode.

An amount of the positive active material may be in a range of about 90 wt % to about 99.5 wt % based on 100 wt % of the positive active material layer, and amounts of the binder and the conductive material may be respectively in a range of about 0.5 wt % to about 5 wt % based on 100 wt % of the positive active material layer.

The positive active material may include a compound (lithiated intercalation compound) that is capable of reversibly intercalating and deintercalating lithium. In some example embodiments, at least one of a composite oxide of lithium and a metal such as or including at least one of cobalt, manganese, nickel, or combinations thereof, may be included.

The composite oxide may be or include a lithium transition metal composite oxide, and examples thereof may include at least one of lithium nickel-based oxide, lithium cobalt-based oxide, lithium manganese-based oxide, lithium iron phosphate-based compound, cobalt-free lithium nickel-manganese-based oxide, or a combination thereof⊏├.

For example, the following compounds represented by any one of the following chemical formulas may be included. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

For example, the positive electrode active material may be or include a high nickel-based positive electrode active material having a nickel amount that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal, excluding lithium in the lithium transition metal composite oxide. The high-nickel-based positive electrode active material may achieve a high capacity, and may be applicable to a high-capacity, high-density rechargeable lithium battery.

The binder is configured to improve binding properties of positive electrode active material particles with one another and with a current collector. Examples of the binder may be or include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene butadiene rubber, a (meth)acrylated styrene butadiene rubber, an epoxy resin, a (meth)acrylic resin, a polyester resin, nylon, or the like, but are not limited thereto.

The conductive material is included to provide electrode conductivity, and any suitable electrically conductive material may be included as an electrically conductive material unless the electrically conductive material causes an adverse chemical change in the battery. Examples of the conductive material may include a carbon-based material such as at least one of natural graphite, artificial graphite, carbon black, acetylene black, Ketjen black, carbon fiber, carbon nanofiber, carbon nanotube, or the like; a metal-based material of a metal powder or a metal fiber including at least one of copper, nickel, aluminum, silver, or the like; a conductive polymer such as a polyphenylene derivative; or a mixture thereof.

The current collector may include Al, but is not limited thereto.

### Electrolyte:

The electrolyte for a rechargeable lithium battery may include a non-aqueous organic solvent and a lithium salt.

The non-aqueous organic solvent is configured as a medium that transmits ions taking part in the electrochemical reaction of a battery.

The non-aqueous organic solvent may include at least one of a carbonate-based, ester-based, ether-based, ketone-based, alcohol-based, aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester-based solvent may include at least one of methyl acetate, ethyl acetate, n-propyl acetate, dimethyl acetate, methyl propionate, ethyl propionate, decanolide, γ-butyrolactone, mevalonolactone, valerolactone, caprolactone, or the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, or the like. The ketone-based solvent may include cyclohexanone, or the like. The alcohol-based solvent may include at least one of ethanol, isopropyl alcohol, and the like. The aprotic solvent may include at least one of nitriles such as R—CN (wherein R is a C2 to C20 linear, branched, or cyclic hydrocarbon group, and may include a double bond, an aromatic ring, or an ether bond, and the like); amides such as dimethylformamide; dioxolanes such as 1,3-dioxolane, 1,4-dioxolane, and the like; sulfolanes, or the like.

The organic solvent may be included alone or in a mixture of two or more solvents.

When the carbonate-based solvent is included, the cyclic carbonate and the linear carbonate may be included together therewith, and the cyclic carbonate and the linear carbonate may be mixed at a volume ratio in a range of about 1:1 to about 1:9.

The electrolyte may further include at least one of vinylethyl carbonate, vinylene carbonate, difluoro ethylene carbonate, chloroethylene carbonate, dichloroethylene carbonate, bromoethylene carbonate, dibromoethylene carbonate, nitroethylene carbonate, cyanoethylene carbonate, fluoroethylene carbonate, or a combination thereof, as an additive.

The lithium salt dissolved in an organic solvent is configured to supply a battery with lithium ions, to operate the rechargeable lithium battery, and to improve transportation of the lithium ions between positive and negative electrodes. Examples of the lithium salt include one, or at least two, supporting electrolyte salts such as or including at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂), where x and y are an integer in a range of about 1 to about 20, lithium trifluoromethane sulfonate, lithium tetrafluoroethane sulfonate, lithium difluorobis(oxalato)phosphate (LiDFBOP), and lithium bis(oxalato) borate (LiBOB).

### Separator:

A separator may be present between the positive electrode and the negative electrode depending on a type of rechargeable lithium battery. The separator may include at least one of polyethylene, polypropylene, polyvinylidene fluoride, or multi-layers thereof having two or more layers, and may be a mixed together multilayer such as a polyethylene/polypropylene double-layered separator, a polyethylene/polypropylene/polyethylene triple-layered separator, a polypropylene/polyethylene/polypropylene triple-layered separator, and the like.

The separator may include a porous substrate and a coating layer including an organic material, an inorganic material, or a combination thereof on one surface, or on both surfaces (e.g., one or two opposing surfaces), of the porous substrate.

The porous substrate may be or include a film formed of or including any one polymer such as at least one of polyolefin such as polyethylene, polypropylene, or the like, polyester such as polyethylene terephthalate, polybutylene terephthalate, or the like, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acryl-based polymer.

The inorganic material may be or include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto.

The organic material and an inorganic material may be mixed in one coating layer, or a coating layer including an organic material and a coating layer including an inorganic material may be stacked together.

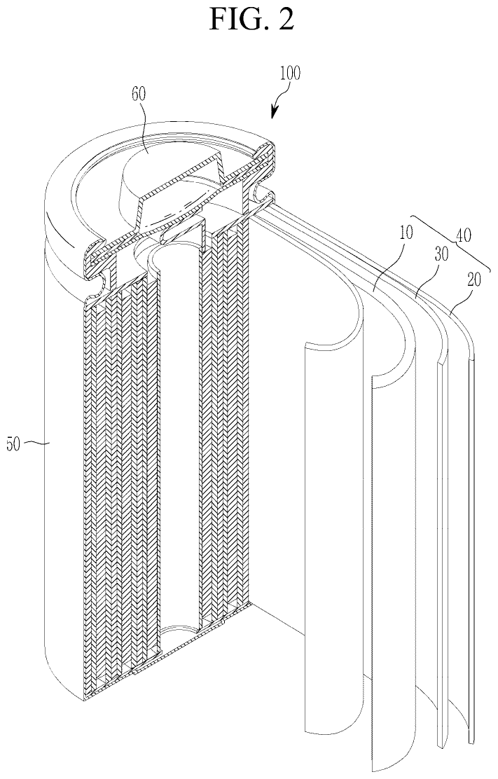

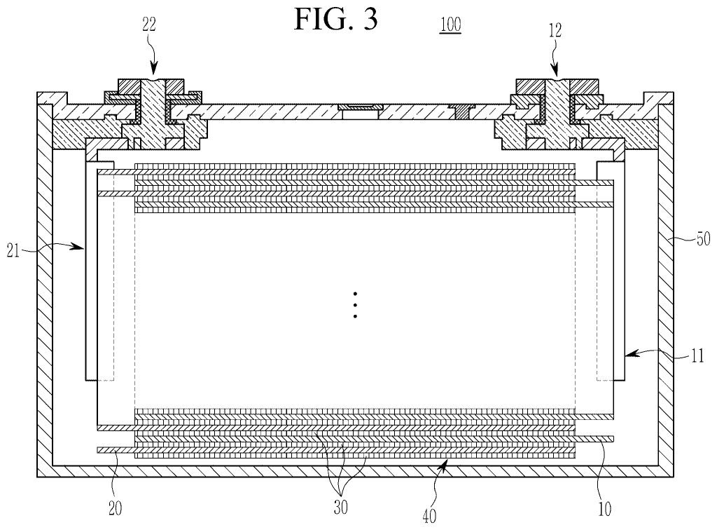

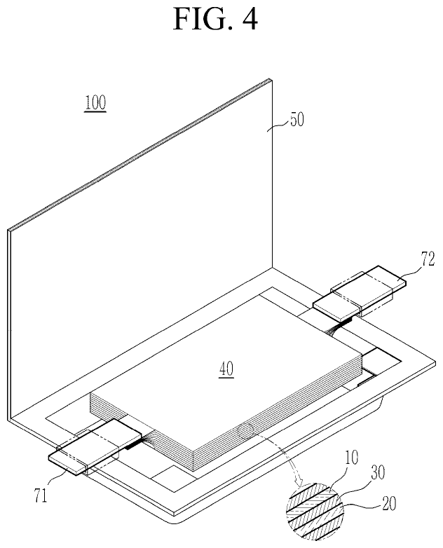

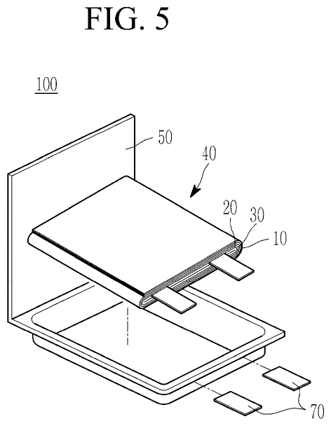

The rechargeable lithium battery may be classified into cylindrical, prismatic, pouch, or coin-type batteries, and the like depending on the shape of the batteries. FIG. 2 to FIG. 5 are schematic views illustrating a rechargeable lithium battery according to an example embodiment, and FIG. 2 shows a cylindrical battery, FIG. 3 shows a prismatic battery, and FIG. 4 and FIG. 5 show pouch-type batteries. Referring to FIG. 2 to FIG. 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte (not shown). The rechargeable lithium battery 100 may include a sealing member 60 that seals the case 50, as shown in FIG. 2. In FIG. 3, the rechargeable lithium battery 100 may include a positive electrode lead tab 11 and a positive terminal 12 connected to the positive electrode lead tab 11, a negative electrode lead tab 21, and a negative terminal 22 connected to the negative electrode lead tab 21. As shown in FIG. 5, the rechargeable lithium battery 100 may include an electrode tab 70, which forms an electrical path for inducing the current formed in the electrode assembly 40 to the outside of the battery 100, or a positive electrode tab 71 and a negative electrode tab 72, as shown in FIG. 4.

The rechargeable lithium battery according to an example embodiment may be applicable to, e.g., automobiles, mobile phones, and/or various suitable types (or kinds) of electric devices, as non-limiting examples.

The following Examples and Comparative Examples are provided in order to highlight characteristics of one or more example embodiments, but it is understood that the Examples and Comparative Examples are not to be construed as limiting the scope of the example embodiments, nor are the Comparative Examples to be construed as being outside the scope of the example embodiments. Further, it is understood that the example embodiments are not limited to the particular details described in the Examples and Comparative Example.

### Example 1

96 wt % of a mixture of artificial graphite and natural graphite (mixing ratio of artificial graphite:natural graphite=5:5 by weight ratio), 2 wt % of a styrene butadiene rubber binder, and 2 wt % of carboxymethyl cellulose thickener were mixed in a water solvent to prepare a first active material layer slurry with a viscosity of 2500 centipoise (cps) to 3000 cps (at 25° C.).

96 wt % of a Si-based negative electrode active material including a silicon core and a soft carbon amorphous carbon layer on the surface of the core, 2 wt % of a styrene butadiene rubber binder, and 2 wt % of a carboxymethyl cellulose thickener were mixed in a water solvent to prepare a second active material layer slurry with a viscosity of 2500 cps to 3000 cps (at 25° C.).

The first active material layer slurry was coated on a Cu foil current collector and then the magnet with a magnetic field of 3000 Gauss was positioned beneath of the current collector to expose the first active material layer slurry to the magnetic field for 10 seconds followed by drying the first active material layer slurry, thereby forming a first active material layer.

After removing the magnet, the second active material layer slurry was coated on the first active material layer and dried to prepare a second active material layer. Thereafter, compression was carried out to prepare a negative electrode. In the prepared negative electrode, the thickness of the first active material layer was 100 μm and the thickness of the second active material layer was 100 μm.

The negative electrode, a lithium metal counter electrode, and an electrolyte were used to fabricate a coin-type half-cell. As the electrolyte, 1.5M LiPF₆ dissolved in a mixed solvent of ethylene carbonate, ethylmethyl carbonate, and dimethyl carbonate (20:10:70 volume ratio) was utilized.

### Example 2

96 wt % of a Si-based negative electrode active material including a silicon core and a soft carbon amorphous carbon layer on the surface of the core, 2 wt % of a styrene butadiene rubber binder, and 2 wt % of a carboxymethyl cellulose thickener were mixed in a water solvent to prepare a first active material layer slurry with a viscosity of 2500 cps to 3000 cps (at 25° C.).

96 wt % of a mixture of artificial graphite and natural graphite (mixing ratio of artificial graphite:natural graphite=5:5 by weight ratio), 2 wt % of a styrene butadiene rubber binder, and 2 wt % of carboxymethyl cellulose thickener were mixed in a water solvent to prepare a second active material layer slurry with a viscosity of 2500 cps to 3000 cps (at 25° C.).

The first active material layer slurry was coated on a Cu foil and dried to prepare a first active material layer. The second active material layer slurry was coated on the first active material layer, the resulting product was positioned on the magnet with a magnetic field of 3000 Gauss to expose the resulting product to the magnetic field for 10 seconds or more, and then dried to prepare a second active material layer followed by compressing the second active material layer, thereby preparing a negative electrode. In the prepared negative electrode, the thickness of the first active material layer was 100 μm and the thickness of the second active material layer was 100 μm.

The negative electrode, a lithium metal counter electrode, and an electrolyte were used to fabricate a coin-type half-cell. As the electrolyte, 1.5M LiPF₆ dissolved in a mixed solvent of ethylene carbonate, ethylmethyl carbonate, and dimethyl carbonate (20:10:70 volume ratio) was utilized.

### Comparative Example 1

96 wt % of artificial graphite, 2 wt % of a styrene butadiene rubber binder, and 2 wt % of carboxymethyl cellulose thickener were mixed in a water solvent to prepare a first active material layer slurry with a viscosity of 2500 cps to 3000 cps (at 25° C.).

96 wt % of a Si-based negative electrode active material including a silicon core and a soft carbon amorphous carbon layer on the surface of the core, 2 wt % of a styrene butadiene rubber binder, and 2 wt % of a carboxymethyl cellulose thickener were mixed in a water solvent to prepare a second active material layer slurry with a viscosity of 2500 cps to 3000 cps (at 25° C.).

The first active material layer slurry was coated on a Cu foil current collector, and then the Cu foil was positioned on the magnet with a magnetic field of 3000 Gauss to expose the first active material layer slurry to the magnetic field for 10 seconds followed by drying the first active material layer slurry, thereby forming a first active material layer.

After removing the magnet, the second active material layer slurry was coated on the first active material layer, and then the magnetic field of 3000 Gauss was repositioned beneath of the current collector to expose the second active material layer slurry to the magnetic field for 10 seconds followed by drying the second active material layer slurry, thereby forming a second active material layer. In the prepared negative electrode, the thickness of the first active material layer was 10 μm and the thickness of the second active material layer was 10 μm.

The negative electrode, a lithium metal counter electrode, and an electrolyte were used to fabricate a coin-type half-cell. As the electrolyte, 1.5M LiPF₆ dissolved in a mixed solvent of ethylene carbonate, ethylmethyl carbonate, and dimethyl carbonate (20:10:70 volume ratio) was utilized.

### Comparative Example 2

96 wt % of a Si-based negative electrode active material including a silicon core and a soft carbon amorphous carbon layer on the surface of the core, 2 wt % of a styrene butadiene rubber binder, and 2 wt % of a carboxymethyl cellulose thickener were mixed in a water solvent to prepare a first active material layer slurry with a viscosity of 2500 cps to 3000 cps (at 25° C.).

96 wt % of artificial graphite, 2 wt % of a styrene butadiene rubber binder, and 2 wt % of carboxymethyl cellulose thickener were mixed in a water solvent to prepare a second active material layer slurry with a viscosity of 2500 cps to 3000 cps (at 25° C.).

The first active material layer slurry was coated on a Cu foil current collector, and then the Cu foil was positioned on the magnet with a magnetic field of 3000 Gauss to expose the first active material layer slurry to the magnetic field for 10 seconds followed by drying the first active material layer slurry, thereby forming a first active material layer.

After removing the magnet, the second active material layer slurry was coated on the first active material layer, and then the magnetic field of 3000 Gauss was repositioned beneath the current collector to expose the second active material layer slurry to the magnetic field for 10 seconds followed by drying the second active material layer slurry, thereby a second active material layer. In the prepared negative electrode, the thickness of the first active material layer was 10 μm and the thickness of the second active material layer was 10 μm.

The negative electrode, a lithium metal counter electrode, and an electrolyte were used to fabricate a coin-type half-cell. As the electrolyte, 1.5M LiPF₆ dissolved in a mixed solvent of ethylene carbonate, ethylmethyl carbonate, and dimethyl carbonate (20:10:70 volume ratio) was utilized.

### Experimental Example 1) Evaluation of X-Ray Diffraction Characteristics (XRD)

The half-cells according to Examples 1 to 2, and Comparative Examples 1 and 2 were twice charged and discharged at 0.1 C, and fully discharged at 0.1 C to 2.75 V. The fully-discharged battery cells were disassembled to obtain negative electrodes. As for the negative electrode, an X-ray diffraction was measured by using X'Pert (available from Malvern Panalytical) XRD equipment with a CuKα ray as a target ray, and removing the monochrometer to improve a peak intensity resolution. Herein, the measurement was performed under a condition of 2θ=10° to 80°, a scan speed (°/S)=0.06436, and a step size of 0.026°/step.

Among the measured results, the peak intensity ratio (I₍₀₀₂₎/I₍₁₁₀₎) of a peak intensity at a (002) plane relative to a peak intensity at a (110) plane of the second active material layer was obtained. The results are shown in Table 1 below. After the second active material layer was removed utilizing the tape, the XRD for the first active material layer was measured under the same condition. The peak intensity ratio (I₍₀₀₂₎/I₍₁₁₀₎) of a peak intensity at a (002) plane relative to a peak intensity at a (110) plane of the first active material layer was obtained. The results are shown in Table 1 below.

TABLE 1

Peak intensity ratio (I₍₀₀₂₎/I₍₁₁₀₎)

| | First active | Second active |
|---|---|---|
| | material layer | material layer |
| Example 1 | 110 | 364 |
| Example 2 | 364 | 110 |
| Comparative Example 1 | 110 | 110 |
| Comparative Example 2 | 110 | 110 |

As shown in Table 1, the first active material layer of Example 1 and the second active material layer of Example 2 were oriented layers. The first and the second active material layers of Comparative Examples 1 and 2 were both oriented layers.

### Experimental Example 2) Evaluation of Room Temperature Cycle-Life Characteristics

The cells according to Examples 1 and 2, and Comparative Examples 1 and 2 were charged at 0.2 C and discharged at 0.2 C at a room temperature (25° C.) within 1.2 V to 0.05 V for 7 cycles. A ratio of the discharge capacity at each cycle relative to the discharge capacity at 1^{st} cycle discharge was determined. The ratio of the discharge capacity at 7^{th} cycle relative to the discharge capacity at 1^{st} cycle discharge for the cell according to Example 1 was 104.5%, and the result indicated that the room-temperature cycle-life characteristics of Example 1 were substantially improved with respect to the room-temperature cycle-life characteristics of Comparative Example 1.

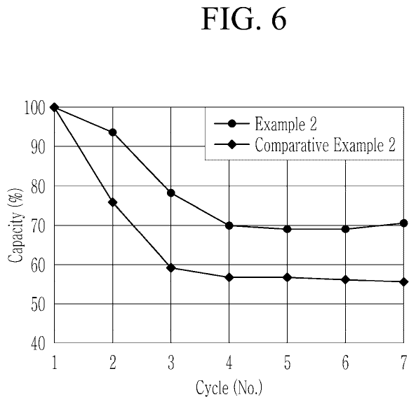

The results of Example 2 and Comparative Example 2 are shown in FIG. 6. As shown in FIG. 6, the room-temperature cycle-life characteristics of Example 2 were substantially improved with respect to the room-temperature cycle-life characteristics of Comparative Example 2.

While this disclosure has been described in connection with what is presently considered to be practical example embodiments, it is to be understood that the disclosure is not limited to the disclosed example embodiments, but, on the contrary, is intended to cover various modifications and equivalent arrangements included within the spirit and scope of the appended claims.

What is claimed is:

1. A negative electrode for a rechargeable lithium battery, the negative electrode comprising:
a current collector;
a first active material layer on the current collector and comprising a first active material; and
a second active material layer on the first active material layer and comprising a second active material,
wherein one of:
the first active material comprises a Si-based active material and the first active material layer is a non-oriented layer; and the second active material comprises crystalline carbon and the second active material layer is an oriented layer, and
the first active material comprises crystalline carbon and the first active material layer is an oriented layer; and the second active material comprises a Si-based active material and the second active material layer is a non-oriented layer.

2. The negative electrode for a rechargeable lithium battery of claim 1, wherein:
the first active material comprises the Si-based active material and the first active material layer is the non-oriented layer; and
the second active material comprises crystalline carbon and the second active material layer is the oriented layer.

3. The negative electrode for a rechargeable lithium battery of claim 1, wherein the oriented layer has a peak intensity ratio (I₍₀₀₂₎/I₍₁₁₀₎) of a peak intensity at a (002) plane relative to a peak intensity at a (110) plane in a range of about 50 to about 200 measured by X-ray diffraction.

4. The negative electrode for a rechargeable lithium battery of claim 1, wherein the oriented layer has a peak intensity ratio (I₍₀₀₂₎/I₍₁₁₀₎) of a peak intensity at a (002) plane relative to a peak intensity at a (110) plane in a range of about 100 to about 200 measured by X-ray diffraction.

5. The negative electrode for a rechargeable lithium battery of claim 1, wherein the oriented layer has a peak intensity ratio (I₍₀₀₂₎/I₍₁₁₀₎ of a peak intensity at a (002) plane relative to a peak intensity at a (110) plane in a range of about 110 to about 200 measured by X-ray diffraction.

6. The negative electrode for a rechargeable lithium battery of claim 1, wherein the non-oriented layer has a peak intensity ratio (I₍₀₀₂₎/I₍₁₁₀₎) of a peak intensity at a (002) plane relative to a peak intensity at a (110) plane of about 300 or more measured by X-ray diffraction.

7. The negative electrode for a rechargeable lithium battery of claim 1, wherein the non-oriented layer has a peak intensity ratio (I₍₀₀₂₎/I₍₁₁₀₎) of a peak intensity at a (002) plane relative to a peak intensity at a (110) plane of more than about 300 and less or equal to about 500 measured by X-ray diffraction.

8. The negative electrode for a rechargeable lithium battery of claim 1, wherein the non-oriented layer has a peak intensity ratio (I₍₀₀₂₎/I₍₁₁₀₎) of a peak intensity at a (002) plane relative to a peak intensity at a (110) plane in a range of about 350 to about 500 measured by X-ray diffraction.

9. The negative electrode for a rechargeable lithium battery of claim 1, wherein the crystalline carbon comprises at least one of artificial graphite, natural graphite, and a combination thereof.

10. The negative electrode for a rechargeable lithium battery of claim 1, wherein the Si-based active material comprises a composite of silicon-carbon.

11. The negative electrode for a rechargeable lithium battery of claim 10, wherein the composite of silicon-carbon comprises a composite of silicon and amorphous carbon.

12. The negative electrode for a rechargeable lithium battery of claim 11, wherein the composite of silicon and amorphous carbon comprises:
silicon particles; and
an amorphous carbon coating layer on a surface of the silicon particles.

13. The negative electrode for a rechargeable lithium battery of claim 10, wherein the silicon-carbon composite further comprises crystalline carbon.

14. The negative electrode for a rechargeable lithium battery of claim 13, wherein the silicon-carbon composite comprises:
a core comprising silicon particles and crystalline carbon, and
an amorphous carbon coating layer on a surface of the core.

15. The negative electrode for a rechargeable lithium battery of claim 1, wherein the non-oriented layer further comprises a carbon-based negative electrode active material.

16. A rechargeable lithium battery, comprising:
the negative electrode of claim 1;
a positive electrode; and
a non-aqueous electrolyte.
